(19) United States
(12) Patent Application Publication
(10) Pub. No.: US 2020/0181959 A1
(43) Pub. Date: Jun. 11, 2020

(54) APPARATUS FOR AN ANTI-BREACH DEVICE ON A DOOR

(71) Applicant: Dennis Beard, Belle Vernon, PA (US)

(72) Inventor: Dennis Beard, Belle Vernon, PA (US)

(21) Appl. No.: 16/216,139

(22) Filed: Dec. 11, 2018

(51) Int. Cl. E05C 17/36

(52) U.S. Cl. CPC E05C 17/36

(57) ABSTRACT

An apparatus for an anti-breach device on a door. The apparatus has a latching mechanism and a strap encased within housing. The housing is mounted to or near a doorframe or wall. The latching mechanism at least partially captures, engages, connects or attaches the door handle. The tension on the strap cinches the latching mechanism and thus tightens the latching mechanism around the door handle to prevent the door from opening either inside or outside.

### BACKGROUND

### 1. Field of the Invention

The present invention relates to an apparatus for an anti-breach device on a door having a hook and a strap encased within a housing that is mounted to a doorframe or wall. In particular, the present invention is related to an apparatus for an anti-breach device on a door that includes a hook and a strap that is encased within a housing that is mounted in the door or door post or wall adjacent the door. The hook of the strap extends out of the housing and captures or at least partially envelopes the door knob of the door and the other end of the strap is firmly pulled away from the housing thus putting pressure on the angles within the housing and preventing the door from opening.

### 2. The Related Art

U.S. Pat. No. 4,288,119 to Geiger shows a cable housed in a tube with a noose fastened around a door knob of a door to be secured against unauthorized intruders. The other end of the cable is attached by a screw as shown in FIG. 1. However, unlike the present invention, the door can be partially opened (See FIG. 3) permitting the tube to be cut or broken.

### SUMMARY

In schools today there is a need for an additional line of defense against unwanted intruders. Due to recent shootings occurring across the nation, schools are on high alert to find ways to protect students and faculty. The challenge is to find a way to protect from within when an intruder has threatened the safety of those within. In an emergency, this device activates easily to keep an intruder out of the classroom and keep those within safe. Activation of the present invention would be undetectable from the outside area. The perpetrator would not know which door is restricted thus slowing his access to students and the faculty. Emergency response would gain time to react to the situation. The present invention would be affixed to the doorframe or wall and always be ready for emergency purposes. The present invention is easy to use with little training needed to activate the device by children and adults.

The present invention overcomes the problems above. In use, a housing is mounted to the doorframe or wall. A hook is provided to capture a door handle with a strap attached to the hook and fed through the housing attached to the doorframe or wall inside the room. The housing is firmly mounted to the doorframe or wall with the strap threaded within the housing and hook secured to the exterior of the housing. A safety seal secures the hook to the exterior and the strap within the housing. In its unrestricted mode, the safety seal is broken by pulling the hook around the housing and capturing the door handle. The opposite end of the strap is cinched by firmly pulling away from the housing thus tightening the hook around the door handle. This acts as a restraining device to prevent anyone from moving the door to open it either to the inside or the outside. Once the strap is no longer cinched, access to the room is easily obtained.

Thus the present invention provides an apparatus for an anti-breach device on a door that includes a hook and a strap that is encased within a housing that is mounted in the door or door post or wall adjacent to the door. The hook of the strap extends out of the housing and captures or at least partially envelopes the door knob of the door and the other end of the strap is firmly pulled away from the housing thus putting pressure on the angles within the housing and preventing the door from opening.

### BRIEF DESCRIPTION OF THE DRAWINGS

FIG. 1 is a perspective view of the present invention showing the back of a housing of the present invention in which the strap is stored;

FIG. 2 is a perspective view of the present invention showing the front of the housing of the present invention in which the strap is stored;

FIG. 3 shows the front and the back of the housing;

FIG. 4 of the present invention shows the hook of the present invention;

FIG. 5 shows the present invention having its housing mounted to the frame of a door;

FIG. 6 shows the housing of the present invention mounted onto the door frame;

FIG. 7 shows a hook of the present invention wherein the hook is connected to one end of a strap of the present invention which is channeled within the housing and the hook engages a door knob of the door; and

FIG. 8 shows the tension on the strap of the present invention as the strap is pulled at an end opposite the end where the hook is connected to the strap thereby activating the device of the present invention.

### BRIEF DESCRIPTION OF THE PEFRRED EMBODIMENT(S)

### Definition of Terms

A door having a handle: A moveable structure used to close off an entrance consisting of a panel that swings on hinges and has a part directly opposite that is designed to be held or operated with the hand.

Handle: A part that is designed to be held or operated with the hand.

Housing: A protective cover made of two (2) pieces with predrilled holes for mounting fasteners and a channel opening for storage and movement of the strap within.

Latching Mechanism: A curved or sharply bent, loped, at least partially encircling shaped device used to catch, connect, or attach to the door handle or its stem.

Strap: A long narrow strip of pliant material.

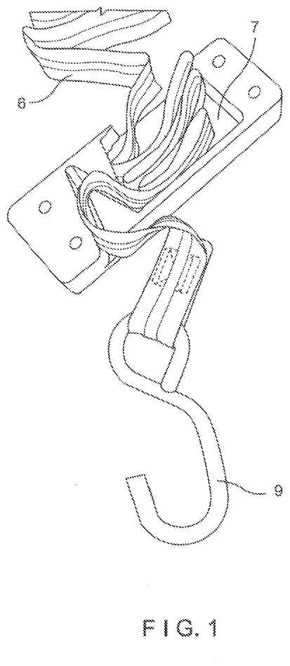

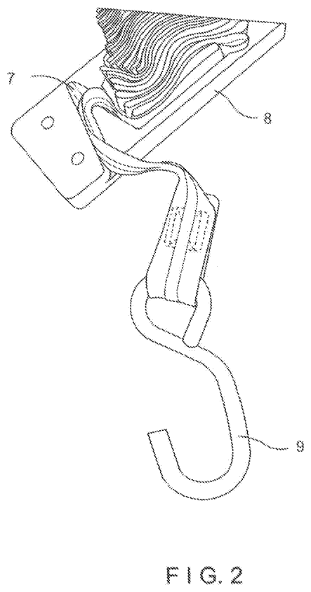

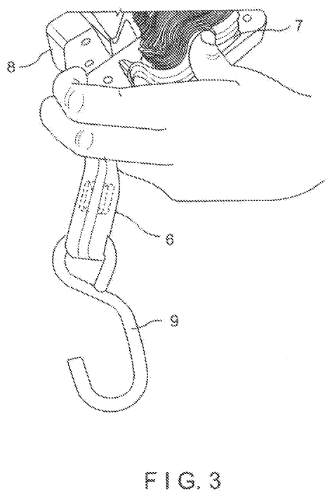

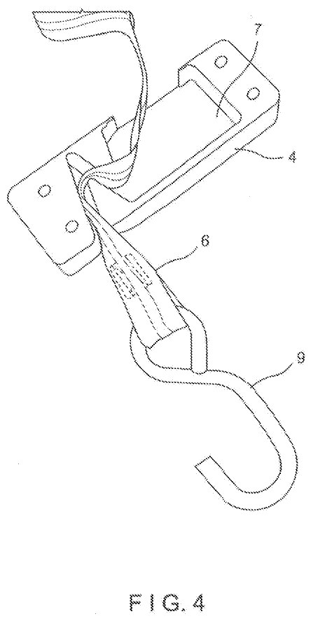

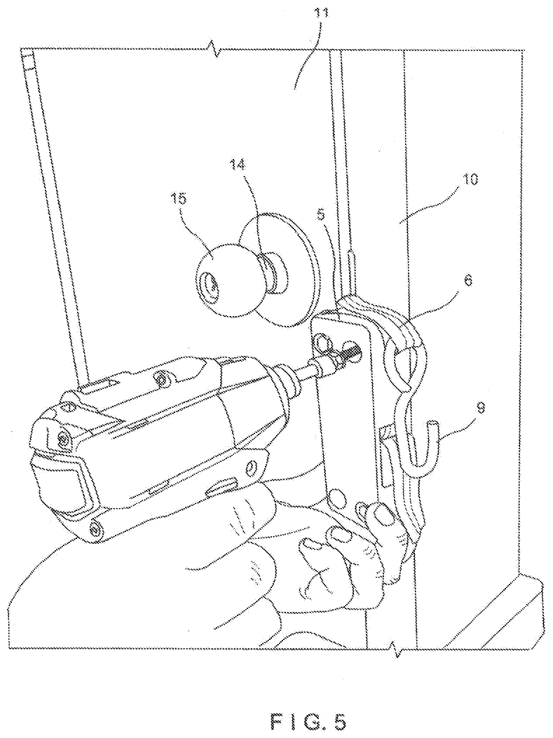

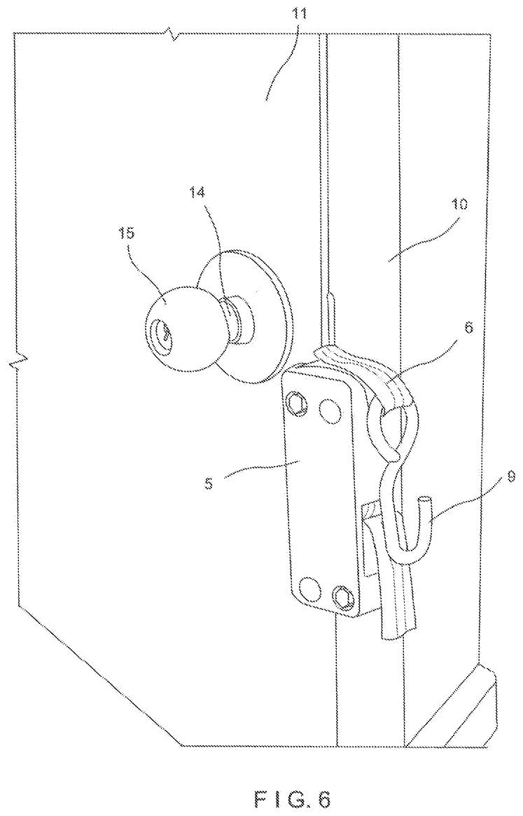

Referring now to the drawings of FIGS. 1-8, FIG.1 shows the back 4 of a housing 5 of the present invention in which the strap 6 is stored within a track 7 of the housing 5 where FIG. 1 shows the rear portion of the track 7. FIG. 2 shows the front 8 of the housing 5 the present invention in which the strap 6 is stored within the track 7 of the housing where FIG.2 shows the rear portion of the track 7 of the housing 5. The housing 5 can be preferably made of UHMW (ultra high molecular polyethylene bar) plastic, aluminum, steel, polycarbonate bras or any other suitable known material. In FIG. 3, the front 8 and the back 4 of the housing 5 are shown. FIG. 4 shows the strap 6 being pulled taunt through the housing 5. The angles of the internal protruding portions pinch or place tension of the strap 6 as it's pulled through the housing 5 making the strap 6 tenser and thus the device more resistant to an intrusion. The latching mechanism 9 of the present invention is shown in FIG. 5 in the embodiment of a hook 9. FIG. 5 shows the strap 6 of the present invention. The strap 6 could preferably be made of either steel, plastic, aluminum, titanium or any other suitable known material. It is understood that the present invention is not limited to a hook 9 but can be a looped material including but not limited to the end of the strap 6 near the door frame 11 being formed as a loop or hook shaped or made of a wire or a plastic material or any material shaped as a loop or hook to fit over the door knob 15 or the stem 14 of door knob 15. In FIG. 5, the present invention is shown with its housing 5 mounted to the frame 11 of a door 10. It is understood that the present invention can have its housing mounted on or near the frame 11 of the door 10 such as the wall adjacent the frame 11. FIG. 6 shows the housing 5 of the present invention after it is mounted onto the door frame 11.

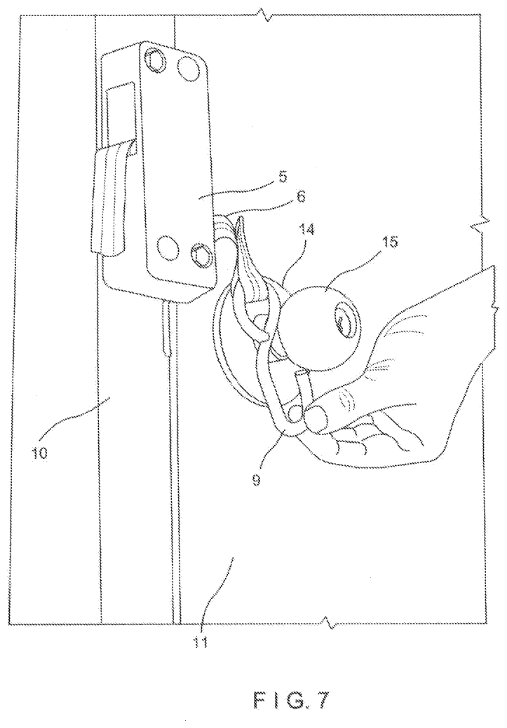

FIG. 7 show the hook 9 of the present invention wherein the hook 9 is connected to one end of a strap 6 of the present invention which is channeled within the track 7 of the housing 5. The hook 9 engages a door knob 15 or the stem 14 of the door knob 15 of the door 11 at least partially, preferably ¾ of the circumference of the door knob 15 or the stem 14 of the door knob 15 to hold the door knob 15 in place when the anti-breach device 5 and 9 of the present invention is activated.

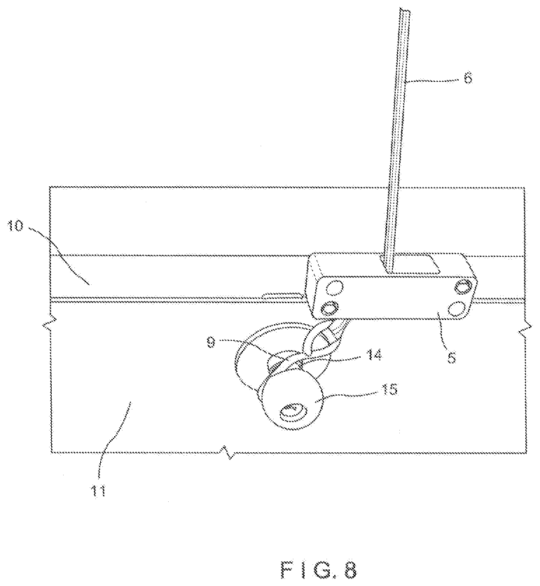

FIG. 8 shows the tension on the strap 6 of the present invention as the strap 6 is pulled at an end opposite the end where the latching mechanism 9 is connected to the strap 6 thereby activating the device 5, 6 and 9 of the present invention.

A safety seal 18 preferably formed as a shrink wrap material preferably made of plastic or other pliant film material preferably completely encases the entire housing 5, strap 6 and latching mechanism 9 to protect against tampering. If the owner of the present invention sees the safety seal 18 has been tampered, damaged, broken or removed the owner will know that the device 5, 6 and 9 has been tampered with. The safety seal 18 can be easily removed for use of the device by the owner.

In operation, the present invention operates as follows as shown in FIGS. 5 and 6.

The safety seal 18 is removed from the device 5, 6 and 9 of the present invention. The latching mechanism 9 is placed at least partially about or connected to the door handle 15 or stem 14 of the door handle 15 after the housing 5 has been mounted on the door frame 10 or near the door frame 10 as described above and illustrated in FIGS. 5 and 6. The other end of the housing 5 has the portion of the strap 6 to be pulled by the user or one or more users or persons inside the room to close the door 11 completely and lock it in place. In this way an intruder is not only locked out of the room where the door 11 has been locked by the present invention but is also unaware of which doors are and are not locked without trying them thus reducing the amount of time the intruder can spend until the police arrive at a location such as a school. It is believed that this present invention will help in these times to increase safety and protect the children, staff and teachers. Of course the present invention can be used in any setting where security precautions are needed or desired.

While presently preferred embodiments have been described for purposes of the disclosure, those skilled in the art can make numerous changes in the arrangement of method steps. Such changes are encompassed within the spirit of the invention as defined by the appended claims.

What is claimed:

1. An apparatus for an anti-breach device on a door, comprising:
a housing;
a latching mechanism and a strap encased within said housing that is mounted to a doorframe or wall, said latching mechanism being fastened or connected to one end of said strap and said latching mechanism being adapted to at least partially attach, connect, latch onto or engage a door knob or a stem of a door knob of said door, said strap having an end opposite that on which said hook is at least partially attached or connected that is adapted to be pulled by a user or one or more users or persons to securely close the door completely to prevent an unwanted intruder from entering or even being aware if the door is in a locked position before attempting to open it.

2. The apparatus according to claim 1 wherein said latching mechanism at least partially engages the door knob or the stem of the door knob approximately ¾ of the circumference of the door knob or the stem of the door knob.

3. The apparatus according to claim 1 wherein the latching mechanism is hook shaped to fit over the door knob or the stem of the door knob.

4. The apparatus according to claim 1 wherein the latching mechanism is a looped material formed with the end of the strap near the door frame as either one of a loop or as hook shaped or otherwise shaped to fit over the door knob or the stem of the door knob.

5. The apparatus according to claim 1 wherein the latching mechanism is a wire formed as either one of a loop or as hook shaped.

6. The apparatus according to claim 1 wherein the latching mechanism is a plastic material shaped as a loop or a hook or otherwise shaped to fit over the door knob or the stem of the door knob.

7. The apparatus according to claim 1 wherein the latching mechanism is wire or any material shaped as a loop or a hook or otherwise shaped to fit over the door knob or the stem of the door knob.

8. The apparatus according to claim 1 further comprising a safety seal preferably formed as a shrink wrap material preferably made of plastic or other pliant film material preferably completely encases the entire housing and latching device to protect against tampering.

9. The apparatus according to claim 1 further comprising said housing is made of a UHMW plastic material.

10. The apparatus according to claim 1 further comprising said housing is made of aluminum.

11. The apparatus according to claim 1 further comprising said housing is made of steel.

12. The apparatus according to claim 1 further comprising said housing is made of polycarbonate brass.

13. The apparatus according to claim 1 further comprising said housing is made of a metallic material.

14. The apparatus of claiml wherein said strap is made of a pliant material.

15. The apparatus according to claiml wherein said strap is made of one of steel, plastic, aluminum or titanium as its pulled through the housing making the strap tenser and thus the device is more resistant to an intrusion.

16. The apparatus according to claiml wherein angles of the internal protruding portions pinch or place tension of the strap as its pulled through the housing making the strap tenser and thus the device is more resistant to an intrusion.
